(19) United States
(12) Patent Application Publication
(10) Pub. No.: US 2024/0273415 A1
(43) Pub. Date: Aug. 15, 2024

(54) Computer-Implemented Data Structure, Method, Inspection Device, and System for Transferring a Machine Learning Model

(71) Applicant: Siemens Aktiengesellschaft, Muenchen (DE)

(72) Inventor: Daniel Schall, Hollabrunn (AT)

(21) Appl. No.: 18/567,473

(22) PCT Filed: Jun. 3, 2022
(86) PCT No.: PCT/EP2022/065207

§ 371 Date: Dec. 6, 2023

(30) Foreign Application Priority Data
Jun. 10, 2021 (EP) 21178877

(51) Int. Cl. G06N 20/00; G06F 18/2415

(52) U.S. Cl. CPC G06N 20/00; G06F 18/2415

(57) ABSTRACT

Method, inspection device, system for transferring a machine learning model and computer-implemented data structure for transferring the machine learning model includes a description for a technical component, a designation for a feature of the component, a classification model for the feature of the component, and at least one sensor parameter that describes the detection of the component by means of at least one sensor element.

### CROSS-REFERENCE TO RELATED APPLICATIONS

This is a U.S. national stage of application No. PCT/EP2022/065207 filed 3 Jun. 2022. Priority is claimed on European Application No. 21178877.3 filed 10 Jun. 2021, the content of which is incorporated herein by reference in its entirety.

### BACKGROUND OF THE INVENTION

### 1. Field of the Invention

The invention relates to a computer program, an electronically readable data carrier, a data carrier signal, a computer-implemented data structure, a computer-implemented method, an inspection apparatus and a system for transferring a machine learning model.

### 2. Description of the Related Art

Modern products frequently contain critical technical components or demanding materials, for the manufacturing of which specific technological capabilities are necessary.

It is often very difficult and also not always feasible for an individual enterprise to have all the required production capabilities available and to implement all the required production steps itself.

A production network is a permanent or temporary coalition of production customers or subscribers, who can share the production systems of, for example, geographically distributed small and medium-sized enterprises and/or comprises original equipment manufacturers (OEM), which work together in a common value creation chain in order to perform joint production.

One example of a production scenario consists in the production of specific parts being delegated to further suppliers. Quality in such cases is one of the most important factors between suppliers and customers.

Improvements in quality management with the reduction of process fluctuations can have a direct effect on a number of key performance indicators in the supply chain.

The continuous improvement of quality management enables errors and, thus, process and production fluctuations to be reduced.

If, in its turn the consistency in the supply chain improves due to the reduction in deviations, cycle times, i.e., the time between two consecutive replenishment procedures, can be shortened and a punctual supply improved.

If fewer errors arise, then the inventory in the supply chain can be reduced, which in many respects is very advantageous. Subscribers in the supply chain, i.e., production customers, only move “good” units and not “defective” units through the supply chain.

Nowadays, sensors such as optical cameras are frequently employed for visual detection of errors, which allow very good error detection after the underlying model has been trained accordingly.

However, a disadvantage in such cases is the effort involved in training the model with the aid of examples such as images of faulty products, which is time-consuming and expensive.

### SUMMARY OF THE INVENTION

It is an object of the present invention to provide systems and method that improve the detection of faulty products and workpieces with the aid of machine learning, and to perform the detection reliably, as quickly as possible and in a simple way.

These and other objects and advantages are achieved in accordance with the invention by a computer-implemented data structure, comprising a description for a technical component, a designation for a feature of the component, a classification model for the feature of the component, and at least one sensor parameter, which describes the detection of the component with the aid of at least one sensor.

A technical component in the present context is understood as a technical product, such as a populated circuit board for a computer apparatus, a semiconductor chip, a plastic product in the form of an injection-molded part, a metal body processed by milling, a chemical or biological compound in the form of a fluid on a carrier structure or in a container.

Now, with aid of the data structure, models and features are transferred from a first inspection system to a second inspection system connected to it.

A respective data set, which has respective data elements for a description for a technical component, a designation for a feature of the technical component, a classification model for the feature of the technical component and at least one sensor parameter, can be derived from the data structure.

In such cases, the effort of training the model can be reduced significantly in a second inspection system, because the models can be used jointly and the effort of training the second or a further inspection system can be reduced.

In production with a lot size of one, this problem can particularly become even more difficult, because data, such as images of faulty products, is rare.

With regard to federated learning, customer contributions can be checked before they are used in the aggregation.

The customer contributions can advantageously be weighted according to relationship metrics such as “trust” and “quality”.

What is achieved by the inventive data structure is that models for machine learning can be exchanged between computing apparatuses, for joint learning, for example. In other words, a standardized interface for the exchange of models is created.

The data structure can be implemented by various data elements and data formats, but always has a description for a component, a designation for a feature of the component, a classification model for the feature of the component and also at least one sensor parameter.

Along with a classification model, the inclusion of a sensor parameter in the data structure particularly allows an improvement in a subsequent similarity analysis, because an adjustment of the classification model to training data of a second inspection system is made possible. This enables the second model to be improved and the detection accuracy for a feature of a component to be increased.

The sensor parameter is a mapping of the technical sensor and allows the sensor to be included in the computer-implemented data structure, such that, for example, during definition of the sensor parameter the sensor can be set accordingly.

Accordingly, the data structure, by its implementation in a computer, is a direct physical mapping of the sensor, where the technical effect in the sensor is linked to the classification model, and allows the model to perform a useful control or analysis of sensor data.

The sensor parameter has a direct relationship to sensor data that is detected by the sensor.

The classification model likewise has a direct relationship to the sensor data that is detected by the sensor.

The sensor detects sensor data of the component and is linked logically and technically to the classification model via the sensor parameter.

In other words, the computer-implemented sensor parameter, in combination with the classification model as a common data structure, allows an efficient interaction with the sensor and an evaluation while using artificial intelligence and improves the internal execution sequence in the activation of the sensor by the computer accordingly with the aid of a classification model, in particular for applications in which a number of data structures are used or the data structures are in distributed storage, as in Cloud solutions or solutions based on federated learning.

Further, through the combined storage of the sensor parameter and the classification model, a simple distinction can be made between different classification models with the aid of the sensor parameters, memory is efficiently used and access times to the memory, when retrieving data structures stored therein, for example, are shortened.

The inventive object is also achieved by a use of the inventive data structure during a visual quality inspection, wherein the sensor parameter comprises a camera parameter.

A visual quality inspection is understood as a visual inspection by an optical imaging sensor, in which a predetermined quality of execution for one or more production steps is compared via a reference image with an image currently recorded and, via a similarity analysis, the degree of the match between the two images is determined by a computing apparatus.

With regard to the visual quality check, the inventive solution supports the joint use of model parameters between different sites and possibly companies in a way that complies with data protection rules. Models can be improved over the course of time without using the data jointly when this is done.

The inventive data structure is particularly advantageous for use in a visual quality inspection, such as in an imaging method, because a received model can be taken into consideration even better for comparison of an image or of a model by the use of a sensor parameter, such as a camera parameter, i.e., by taking into consideration camera settings, such as orientation, distance, focal length, and/or exposure time.

The inventive object is also achieved by an inspection apparatus for use when transferring a machine learning model, comprising an acquisition sensor, a computing apparatus with a memory, where the computing apparatus is configured to create, apply or train a machine-learning model with the aid of a data set, which is based on the inventive data structure.

The inspection apparatus is provided with the technical component and analyzed by an analysis apparatus included before it, where the previously mentioned model is applied.

What is achieved by this is that a machine learning model, which is applied by a computer apparatus with a memory, can be created and/or trained with the aid of a data set received, through which the receipt of the received model is simplified, the training time is shortened, and the model accuracy can be improved.

The inventive object is also achieved by a system for transmission of a machine learning model, comprising a first and at least one second inventive inspection apparatus, connected to one another, where the first inspection apparatus is configured to derive a data set, which is based on the inventive data structure, from the model of the first inspection apparatus, and to transfer the data set to the at least one second inspection apparatus, with the at least one second inspection apparatus being configured to create, apply or train its model with the data set received from the first inspection apparatus.

The inspection apparatus comprised by the system is provided with the technical component and analyzed by an analysis apparatus also included, where the previously mentioned model is applied.

What is achieved by this is that a machine learning model can be applied very easily by a number of subscribers in a system, whereby the training time is shortened and the model accuracy can be improved.

In a embodiment of the inventive system, the first and at least one second inspection apparatus are connected to one another via a server, which has a computing apparatus with a memory and the computing apparatus is configured to receive the first data set from the first inspection apparatus and to create, apply or train an overall model from the received data set.

What is achieved by this is that, as well as a Peer-to-Peer (PtP) connection, a client-server transmission can also occur via inspection apparatuses lying at edges or linked to a respective edge, where a “global” model or the respective part models of individual customers or subscribers is stored on the server.

An edge is understood as a computing apparatus that can communicate with a further edge or a server and is linked to a local computing apparatus, such as an inspection apparatus, which applies a machine learning model with sensors.

The inventive object is also achieved by a computer-implemented method, where a first inspection apparatus has a first machine learning model, from which first model a data set based on the inventive data structure is derived, the data set is transferred to at least one second inspection apparatus with a second machine learning model, and the second model is trained with the aid of the data set.

In a embodiment of the inventive method, for the first mode model, a least one weight function is applied during training of the second model.

What is achieved by this is that production data of various customers or subscribers can be taken into consideration individually and a more accurate overall model can be established.

The inventive object is also achieved by a computer program, comprising commands when, when executed by a computer, cause the computer to implement the inventive method.

The inventive object is also achieved by an electronically readable data carrier with readable control information stored thereon, which comprises at least the inventive computer program and which is configured such that, when the data carrier is used in a computer facility, it performs the inventive method.

The inventive object is also achieved by a data carrier signal, which transmits the inventive computer program.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in greater detail below in the exemplary embodiment illustrated in the enclosed drawings, in which:

FIG. 1 shows an exemplary embodiment of the inventive data structure;

FIG. 2 shows an exemplary embodiment for a production scenario;

FIG. 3 shows an exemplary embodiment of a dummy code for averaging using trust and quality weightings for a number of manufacturers; and

FIG. 4 is a flowchart of the method in accordance with the invention.

### BRIEF DESCRIPTION OF THE EXEMPLARY EMBODIMENTS

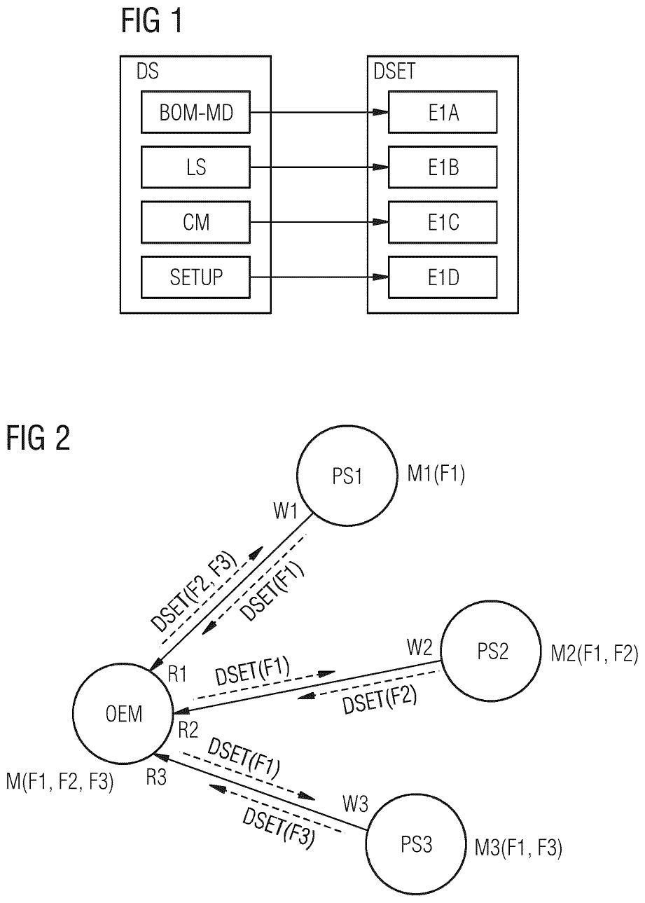

FIG. 1 shows an exemplary embodiment for the inventive data structure DS, which serves as a template for a data set DSET with data elements E1A-E1D. The template can be used by any production subscriber, in order, for example, to transfer corresponding data sets to an overall manufacturer.

In this example, the data structure is used for a Visual Quality Inspection (VQI). A sensor parameter SETUP comprises camera parameters, for example, the alignment, the focal length or the resolution of the camera sensor.

The computer-implemented data structure DS for transferring a machine learning model comprises:
a description BOM-MD (Bill-of-Material metadata) for a technical component: for example, in the form of parts list metadata, which concentrates on a product or parts of a product at a specific point in time. This parts list metadata makes clear the product for which the model can be used.
The assigned data set DSET designates a component “gear unit” as description E1A.
The component E1A “gear unit” has a number of parts. It is of no significance, however, how the component has been manufactured or put together. The component can therefore have been assembled automatically or manually.
A designation LS (label set) for a feature E1B “loose screw” of the component E1A “gear unit”.
The designation LS includes a “problem description”, which is to be recognized by application of a VQI model and in this example describes the feature “loose screw”.
The designation LS is linked to an image of the component E1A and above and beyond this can have a marking within the image in order to identify the relevant area of the picture. For each designation a current image with the corresponding errors is available in order to offer the recipient of the data set DSET the opportunity of verifying the correctness of the designation predicted by the model.
a classification model CM as element E1C in the data set DSET for the feature E1B “loose screw” of the component E1A “gear unit”. Any type of machine learning model or deep-learning-based learning can be used, such as a “Convolutional Neural Network” (CNN).
The model E1C can, for example, be used as a reference to artefacts in a model repository or can be embedded as a binary artefact, which can be loaded by the VOI run time.
at least one sensor parameter SETUP as element E1D in data set DSET, which describes the detection of the component E1A “gear unit” with the aid of at least one sensor in the form of a camera.
The recipient of a VOI template must make sure that their camera system generates similar images of the product to the creator of the template.
Otherwise, the classification model does not lead to good results. In practice, it is not always possible and necessary to create exactly the same images, but the angle of view of the camera should be consistent for the various VQI installations.
If the camera is placed in relation to the product, this can influence the manner in which the VOI model can recognize product errors.
A reference image is specified for this purpose, which is compared automatically by an algorithm with the image from the new VOI camera installation in order to check the camera position.
The user is given hints as to how the camera position can be adjusted accordingly so that similar images are created, which are advantageous for a precise similarity comparison.

FIG. 2 shows an exemplary embodiment of a production scenario with a number of customers or subscribers (“Production Suppliers”) PS1-PS3.

Knowledge created is now to be combined in the production network for improving the quality checking.

The VOI models are used independently of one another in the factory of a respective supplier, preferably in corresponding computing apparatuses for machine learning with storage at the edge.

A model can be refined as soon as new data, such as images and labels, becomes available.

There can also be corrections in designations, i.e., in the tags, thus incorrect classifications that can be corrected by the operator.

The models are newly trained independently of one another based on their local data.

A federation and model improvement allows the exchange of model weights between various production sites, but without exchanging the current production data itself.

The subscribers PS1-PS3 as a supplier federation (federated clients) can each notify their models M1-M3 inclusive of sensor parameter SETUP for respective features F1-F3 for a description BOM-MD and a designation LS to an Original Equipment Manufacturer OEM as a “federated server” with the aid of their respective VOI model weights W1-W3 for data aggregation by means of corresponding data sets DSET, which incorporates the models M1-M3 into an overall model M.

Here, the models M1-M3 and also the overall model M can be continuously updated and improved. To this end, a corresponding identification can be helpful, for example, via a version number of a time stamp for the model.

It is possible for either part models M1-M3 or the overall model M to be offered to the subscribers PS1-PS3 for further use, who then accordingly load and use the respective data sets DSET.

The weights when taking into consideration individual models M1-M3 in an overall model M can be checked in this case by:

$$\begin{matrix}Δ W 1 = W 1 - \overline{W} \\ Δ W 2 = W 2 - \overline{W} \\ Δ W 3 = W 3 - \overline{W}\end{matrix}$$

where W̅ is the average weight matrix and N is the number of subscribers PS1-PS3 (clients).

$$\overline{W} = ( W 1 + W 2 + W 3 ) / N$$

Contributions to weights of the subscribers are rejected if a weight difference ΔW exceeds a predefined threshold value.

The weight difference ΔW can vary very greatly compared to other subscribers, because there can be different error classes or different ambient conditions in the supplier's factory.

The weighting of the subscriber can be built on trust.

TABLE 1
Weighting according to trust

| Subscriber | Number of products | Weight wt |
|---|---|---|
| A | 100 | 100/160 = 0.625 |
| B | 50 | 50/160 = 0.313 |
| C | 10 | 10/160 = 0.063 |
| Total | 160 | |

Table 1 shows an example of “trust” weights of various subscribers.

Each subscriber has a respective relationship R1-R3 to the server OEM. The “trust” weights wt(1)-wt(3) are assigned to the respective subscribers PS1-PS3 via the strength of the relationships R1-R3.

The weighting can be based on “quality”.

TABLE 2
Weighting according to quality

| | Number of | | |
|---|---|---|---|
| Subscribers | products | Defects | Weight wq |
| A | 100 | 5 | 100/5 = 20 → 20/40 = 0.5 |
| B | 50 | 5 | 50/5 = 10 → 10/40 = 0.25 |
| C | 10 | 1 | 10/1 = 10 → 10/40 = 0.25 |
| Total | 160 | | |

Table 2 shows exemplary quality weights of various production subscribers.

Each subscriber can produce defective products. The more defective workpieces or products are produced by a subscriber, the lower the expected production maturity of the respective subscriber will be and the lower the contributions will be weighted in the averaging method.

Different “quality” weights wq(1)-wq(3) can therefore be linked to the respective subscriber.

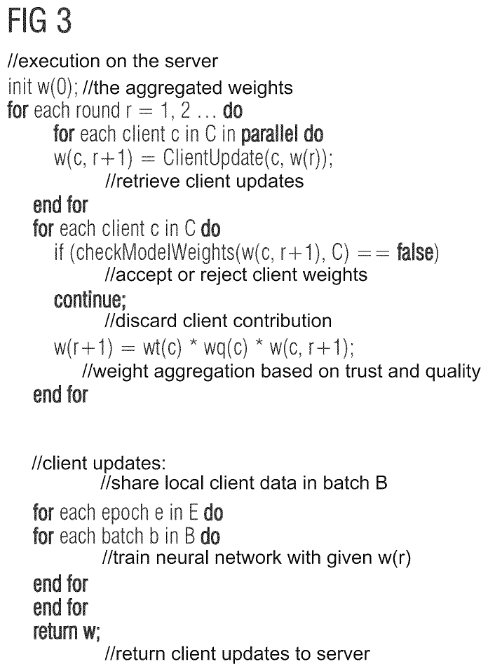

FIG. 3 shows an exemplary embodiment of a dummy code for averaging using trust and quality weightings for a number of producers.

The weighting is undertaken based on a “federated averaging” method, in which trust and quality are taken into account for each subscriber via the respective weights wt(1)-wt(3) and wq(1)-wq(3).

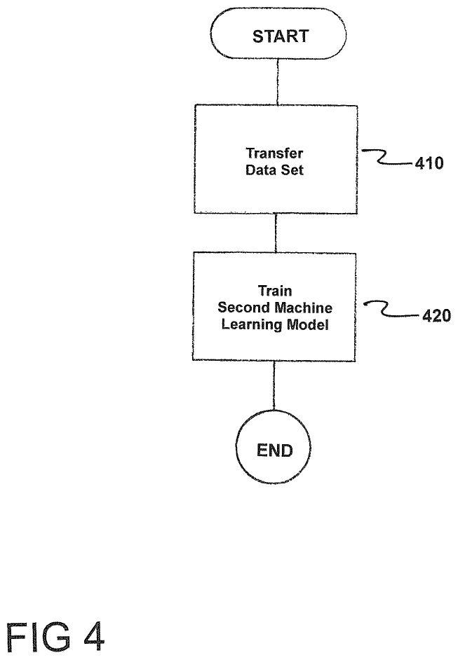

FIG. 4 is a flowchart of a computer-implemented method for transferring a machine learning model, where a first inspection apparatus includes a first machine learning model, from which a data set DSET, based on a data structure DS, is derived.

The method comprises transferring the data set DSET to at least one second inspection apparatus including a second machine, as indicated in step 410.

Next, the second machine learning model is trained via the transferred data set DSET, as indicated in step 420.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A computer-implemented data structure for transferring a machine learning model, comprising:
a description for a technical component;
a designation for a feature of the component;
a classification model for the feature of the component; and
at least one sensor parameter, which describes acquisition of the component via at least one sensor.

12. The computer-implemented data structure as claimed in claim 11, wherein the computer-implemented data is utilized to transfer the machine learning model during a visual quality inspection; and wherein the sensor parameter comprises a camera parameter.

13. An inspection apparatus for use during transfer of a machine learning model, comprising:
a detection sensor; and
a computing apparatus including a memory;
wherein the computing apparatus is configured to create, apply or train a model for machine learning via a data set which is based on a computer-implemented data structure for transferring the machine learning model, the computer-implemented data structure comprising:
a description for a technical component;
a designation for a feature of the component;
a classification model for the feature of the component; and
at least one sensor parameter, which describes acquisition of the component via at least one sensor.

14. A system for transferring a machine learning model, comprising:
a first and at least one second inspection apparatus connected to each other;
wherein the first inspection apparatus is configured to derive a data set, which is based on the data structure as recited in claim 13, from a model of the first inspection apparatus, and is configured to transfer the data set to the at least one second inspection apparatus, said at least one second inspection apparatus being configured to create, to apply or to train another model of the at least one second inspection apparatus with the data set received from the first inspection apparatus.

15. The system as claimed in claim 14, wherein the first and at least one second inspection apparatus are interconnected via a server including a computing apparatus having a memory, the computing apparatus being configured to receive the data set from the first inspection apparatus and to create, apply or train an overall model from the received data set.

16. A computer-implemented method for transferring a machine learning model, a first inspection apparatus including a first machine learning model from which a data set, based on a data structure is derived, the method comprising:
transferring the data set to at least one second inspection apparatus including a second machine learning model; and
training the second machine learning model via the transferred data set.

17. The method as claimed in claim 16, wherein at least one weight function for the first machine learning model is applied during training of the second model.

18. A computer program, comprising commands which, when executed by a computer, cause said computer to implement the method as claimed in claim 15.

19. An non-transitory electronically-readable data carrier encoded with readable control information which comprises at least a computer program which, when executed in at a computing facility, causes transference of a machine learning model, a first inspection apparatus including a first machine learning model from which a data set, based on a data structure being derived, the computer program comprising:
control information for transferring the data set to at least one second inspection apparatus including a second machine learning model; and
control information for training the second machine learning model via the data set.

20. A data carrier signal, which transmits the computer program as claimed in claim 17.
